(19) United States
(12) Patent Application Publication
(10) Pub. No.: US 2026/0270907 A1
(43) Pub. Date: Sep. 10, 2026

(54) NON-CELL-DEFINING SYNCHRONIZATION SIGNAL BURSTS FOR IDLE MODE

(71) Applicant: QUALCOMM Incorporated, San Diego, CA (US)

(72) Inventors: Linhai HE, San Diego, CA (US); Masato KITAZOE, Hachiouji-shi (JP); Prashant SHARMA, San Marcos, CA (US); Ruiming ZHENG, Beijing (CN); Yongjun KWAK, San Diego, CA (US); Jing LEI, San Diego, CA (US); Nazmul ISLAM, Littleton, MA (US)

(21) Appl. No.: 18/881,492

(22) PCT Filed: Sep. 3, 2022
(86) PCT No.: PCT/CN2022/116924

§ 371 Date: Jan. 6, 2025

(51) Int. Cl. H04W 56/00; H04W 52/02; H04W 52/32

(52) U.S. Cl. CPC H04W 56/0045; H04W 52/0235; H04W 52/325

(57) ABSTRACT

Various aspects of the present disclosure generally relate to wireless communication. In some aspects, a user equipment (UE) may receive a cell-defining (CD) synchronization signal burst (SSB). The UE may obtain a location of an initial bandwidth part (BWP) that is specific to UEs with reduced capabilities (RedCap UEs) based at least in part on system information. The UE may obtain one or more parameters for a non-CD (NCD) SSB based at least in part on a configuration for the initial BWP. The UE may receive the NCD-SSB in the initial BWP based at least in part on the one or more parameters. Numerous other aspects are described.

### FIELD OF THE DISCLOSURE

Aspects of the present disclosure generally relate to wireless communication and to techniques and apparatuses for using non-cell-defining synchronization signal bursts for an idle mode.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a cell-defining (CD) synchronization signal burst (SSB). The method may include obtaining a location of an initial bandwidth part (BWP) that is specific to UEs with reduced capabilities based at least in part on system information. The method may include obtaining one or more parameters for a non-CD (NCD) SSB based at least in part on a configuration for the initial BWP. The method may include receiving the NCD-SSB in the initial BWP based at least in part on the one or more parameters.

Some aspects described herein relate to a method of wireless communication performed by a network node. The method may include transmitting a CD-SSB. The method may include determining one or more parameters for an NCD-SSB based at least in part on a configuration for an initial BWP that is specific to UEs with reduced capabilities. The method may include transmitting the NCD-SSB in the initial BWP based at least in part on the one or more parameters.

Some aspects described herein relate to a method of wireless communication performed by a UE. The method may include receiving a CD-SSB. The method may include obtaining a location of an NCD-SSB based at least in part on a mapping associated with a system information block (SIB). The method may include receiving the NCD-SSB in the location.

Some aspects described herein relate to a method of wireless communication performed by a network node. The method may include transmitting a CD-SSB. The method may include transmitting an NCD-SSB in a location that is based at least in part on a mapping associated with a SIB in the CD-SSB.

Some aspects described herein relate to a UE for wireless communication. The UE may include a memory and one or more processors coupled to the memory. The one or more processors may be configured to receive a CD-SSB. The one or more processors may be configured to obtain a location of an initial BWP that is specific to UEs with reduced capabilities based at least in part on system information. The one or more processors may be configured to obtain one or more parameters for an NCD-SSB based at least in part on a configuration for the initial BWP. The one or more processors may be configured to receive the NCD-SSB in the initial BWP based at least in part on the one or more parameters.

Some aspects described herein relate to a network node for wireless communication. The network node may include a memory and one or more processors coupled to the memory. The one or more processors may be configured to transmit a CD-SSB. The one or more processors may be configured to determine one or more parameters for an NCD-SSB based at least in part on a configuration for an initial BWP that is specific to UEs with reduced capabilities. The one or more processors may be configured to transmit the NCD-SSB in the initial BWP based at least in part on the one or more parameters.

Some aspects described herein relate to a UE for wireless communication. The UE may include a memory and one or more processors coupled to the memory. The one or more processors may be configured to receive a CD-SSB. The one or more processors may be configured to obtain a location of an NCD-SSB based at least in part on a mapping associated with a SIB. The one or more processors may be configured to receive the NCD-SSB in the location.

Some aspects described herein relate to a network node for wireless communication. The network node may include a memory and one or more processors coupled to the memory. The one or more processors may be configured to transmit a CD-SSB. The one or more processors may be configured to transmit an NCD-SSB in a location that is based at least in part on a mapping associated with a SIB in the CD-SSB.

Some aspects described herein relate to a non-transitory computer-readable medium that stores a set of instructions for wireless communication by a UE. The set of instructions, when executed by one or more processors of the UE, may cause the UE to receive a CD-SSB. The set of instructions, when executed by one or more processors of the UE, may cause the UE to obtain a location of an initial BWP that is specific to UEs with reduced capabilities based at least in part on system information. The set of instructions, when executed by one or more processors of the UE, may cause the UE to obtain one or more parameters for an NCD-SSB based at least in part on a configuration for the initial BWP. The set of instructions, when executed by one or more processors of the UE, may cause the UE to receive the NCD-SSB in the initial BWP based at least in part on the one or more parameters.

Some aspects described herein relate to a non-transitory computer-readable medium that stores a set of instructions for wireless communication by a network node. The set of instructions, when executed by one or more processors of the network node, may cause the network node to transmit a CD-SSB. The set of instructions, when executed by one or more processors of the network node, may cause the network node to determine one or more parameters for an NCD-SSB based at least in part on a configuration for an initial BWP that is specific to UEs with reduced capabilities. The set of instructions, when executed by one or more processors of the network node, may cause the network node to transmit the NCD-SSB in the initial BWP based at least in part on the one or more parameters.

Some aspects described herein relate to a non-transitory computer-readable medium that stores a set of instructions for wireless communication by a UE. The set of instructions, when executed by one or more processors of the UE, may cause the UE to receive a CD-SSB. The set of instructions, when executed by one or more processors of the UE, may cause the UE to obtain a location of an NCD-SSB based at least in part on a mapping associated with a SIB. The set of instructions, when executed by one or more processors of the UE, may cause the UE to receive the NCD-SSB in the location.

Some aspects described herein relate to a non-transitory computer-readable medium that stores a set of instructions for wireless communication by a network node. The set of instructions, when executed by one or more processors of the network node, may cause the network node to transmit a CD-SSB. The set of instructions, when executed by one or more processors of the network node, may cause the network node to transmit an NCD-SSB in a location that is based at least in part on a mapping associated with a SIB in the CD-SSB.

Some aspects described herein relate to an apparatus for wireless communication. The apparatus may include means for receiving a CD-SSB. The apparatus may include means for obtaining a location of an initial BWP that is specific to UEs with reduced capabilities based at least in part on system information. The apparatus may include means for obtaining one or more parameters for an NCD-SSB based at least in part on a configuration for the initial BWP. The apparatus may include means for receiving the NCD-SSB in the initial BWP based at least in part on the one or more parameters.

Some aspects described herein relate to an apparatus for wireless communication. The apparatus may include means for transmitting a CD-SSB. The apparatus may include means for determining one or more parameters for an NCD-SSB based at least in part on a configuration for an initial BWP that is specific to UEs with reduced capabilities. The apparatus may include means for transmitting the NCD-SSB in the initial BWP based at least in part on the one or more parameters.

Some aspects described herein relate to an apparatus for wireless communication. The apparatus may include means for receiving a CD-SSB. The apparatus may include means for obtaining a location of an NCD-SSB based at least in part on a mapping associated with a SIB. The apparatus may include means for receiving the NCD-SSB in the location.

Some aspects described herein relate to an apparatus for wireless communication. The apparatus may include means for transmitting a CD-SSB. The apparatus may include means for transmitting an NCD-SSB in a location that is based at least in part on a mapping associated with a SIB in the CD-SSB.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a synchronization signal (SS) hierarchy, in accordance with the present disclosure.

FIG. 5 is a diagram illustrating an example associated with performing idle mode procedures based on a non-cell-defining SS burst (NCD-SSB), in accordance with the present disclosure.

FIG. 6 is a diagram illustrating an example associated with cell reselection, in accordance with the present disclosure.

FIG. 7 is a diagram illustrating an example associated with performing idle mode procedures based on an NCD-SSB, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

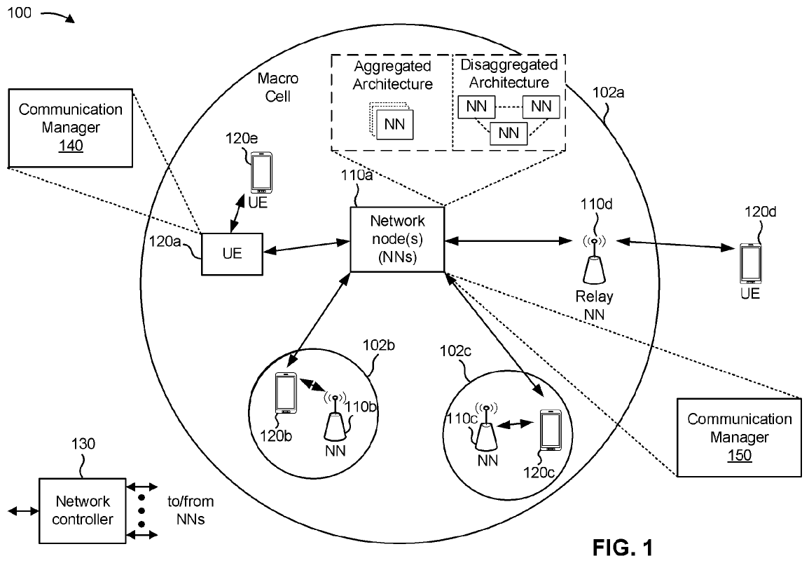

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

UEs may be of different categories for different capabilities. For example, a network node may serve a first category of UEs that have a less advanced capability (e.g., a lower capability and/or a reduced capability) and a second category of UEs that have a more advanced capability (e.g., a higher capability). A UE of the first category may have a reduced feature set compared to UEs of the second category, and may be referred to as a reduced capability (RedCap) UE, a low tier UE, NR-Light UE, and/or an NR-Lite UE, among other examples. A UE of the first category may be, for example, industrial wireless sensors, low-end smartphones, health monitors, video surveillance, high-end wearables, MTC devices, and/or high-end logistic trackers.

A UE of the second category may have an advanced feature set compared to UEs of the first category, and may be referred to as a baseline UE, a high tier UE, an NR UE, and/or a premium UE, among other examples. A UE of the second category may include enhanced mobile broadband (eMBB) devices, ultra-reliable low latency communication (URLLC) devices, extended reality (XR) devices, laptops, robots, industrial machines, and/or high-end smartphones. UEs of the first category may support a lower maximum modulation and coding scheme (MCS) than UEs of the second category (e.g., quadrature phase shift keying (QPSK) or the like as compared to 256-quadrature amplitude modulation (QAM) or the like), may support a lower maximum transmit power than UEs of the second category, may have a less advanced beamforming capability than UEs of the second category (e.g., may not be capable of forming as many beams as UEs of the second category), may require a longer processing time than UEs of the second category, may include less hardware than UEs of the second category (e.g., fewer antennas, fewer transmit antennas, and/or fewer receive antennas), and/or may not be capable of communicating on as wide of a maximum bandwidth part as UEs of the second category, among other examples. Additionally, or alternatively, UEs of the second category may be capable of communicating using a shortened transmission time interval (TTI) (e.g., a slot length of 1 ms or less, 0.5 ms, 0.25 ms, 0.125 ms, 0.0625 ms, or the like, depending on a sub-carrier spacing), and UEs of the first category may not be capable of communicating using the shortened TTI.

There may be a third category of devices that may be referred to as enhanced RedCap (eRedCap) devices or NR-Superlight devices. Such devices may include eMTC devices, and/or NB-IoT devices in associated with 3GPP Release 18 and/or massive IoT. UEs of the third category may include, for example, low-end industrial sensors, parking sensors, agricultural sensors, utility meters, low-end wearables, and/or low-end asset trackers. Just as UE capabilities of the first category differ from UE capabilities of the second category. UE capabilities of the third category may differ from UE capabilities of the first category and the second category.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR 1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FRI, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a CD-SSB and obtain a location of an initial bandwidth part (BWP) that is specific to UEs with reduced capabilities based at least in part on system information. The communication manager 140 may obtain one or more parameters for an NCD-SSB based at least in part on a configuration for the initial BWP. The communication manager 140 may receive the NCD-SSB in the initial BWP based at least in part on the one or more parameters.

In some aspects, the communication manager 140 may receive a CD-SSB and obtain a location of an NCD-SSB based at least in part on a mapping associated with a system information block (SIB). The communication manager 140 may receive the NCD-SSB in the location. Additionally, or alternatively, the communication manager 140 may perform one or more other operations described herein.

In some aspects, a network node (e.g., network node 110) may include a communication manager 150. As described in more detail elsewhere herein, the communication manager 150 may transmit a CD-SSB and determine one or more parameters for an NCD-SSB based at least in part on a configuration for an initial BWP that is specific to UEs with reduced capabilities. The communication manager 150 may transmit the NCD-SSB in the initial BWP based at least in part on the one or more parameters.

In some aspects, the communication manager 150 may transmit a CD-SSB and transmit an NCD-SSB in a location that is based at least in part on a mapping associated with a SIB in the CD-SSB. Additionally, or alternatively, the communication manager 150 may perform one or more other operations described herein.

As indicated above, FIG. 1 is provided as an example. Other examples may differ from what is described with regard to FIG. 1.

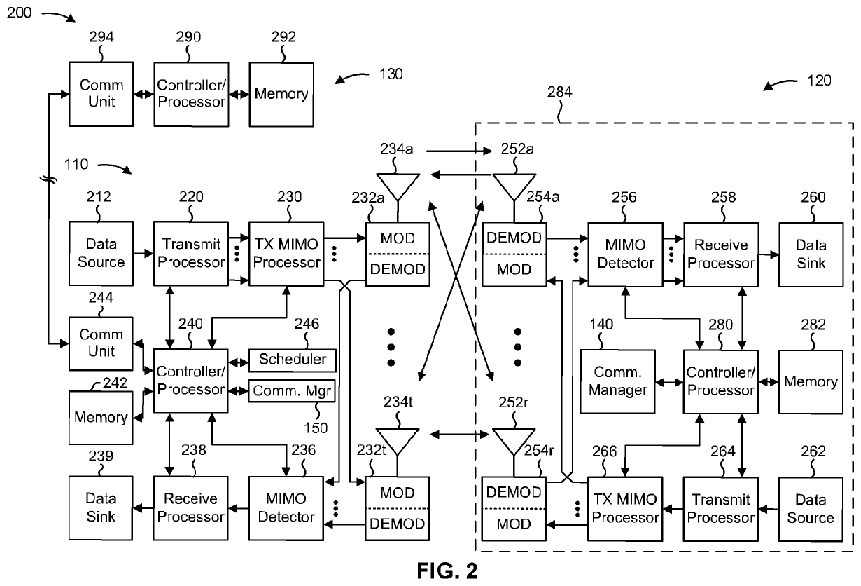

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more MCSs for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

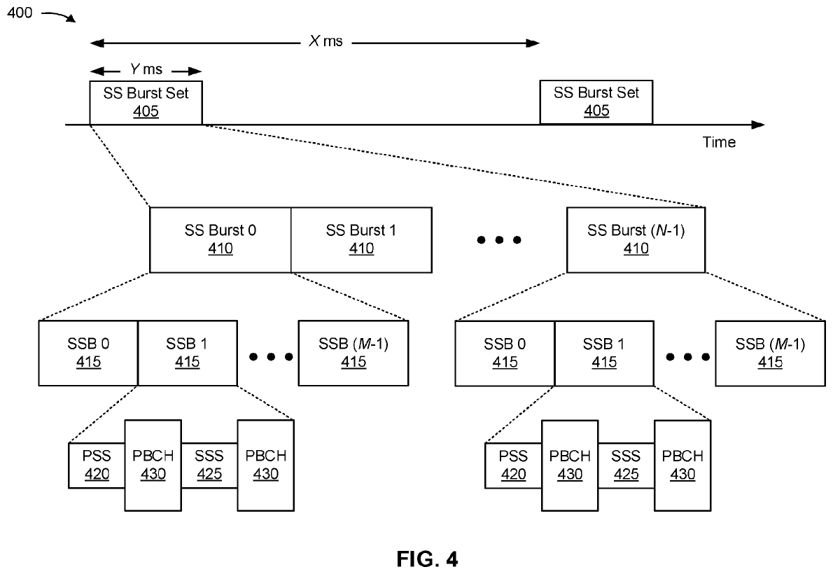

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-13).

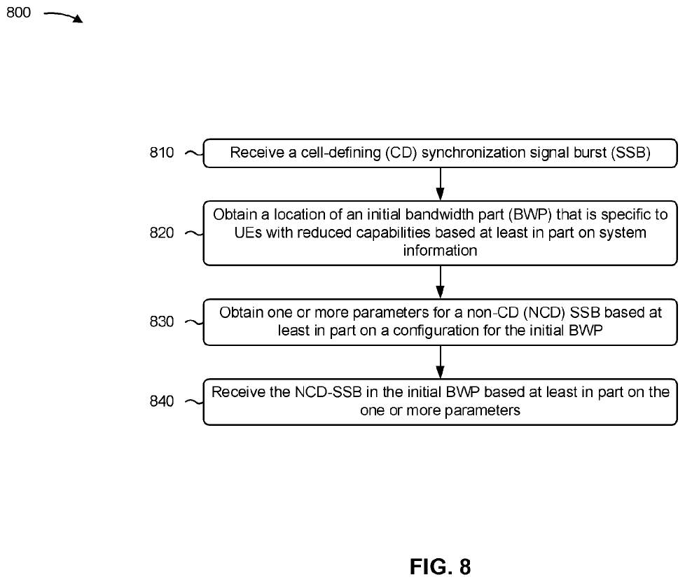

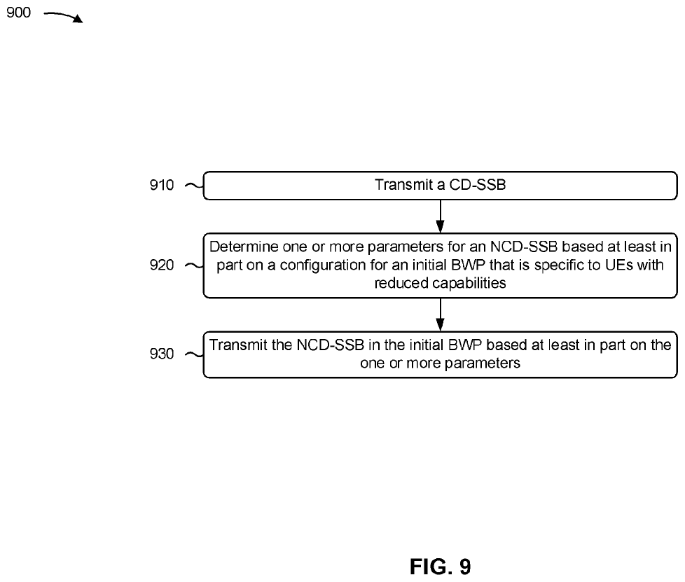

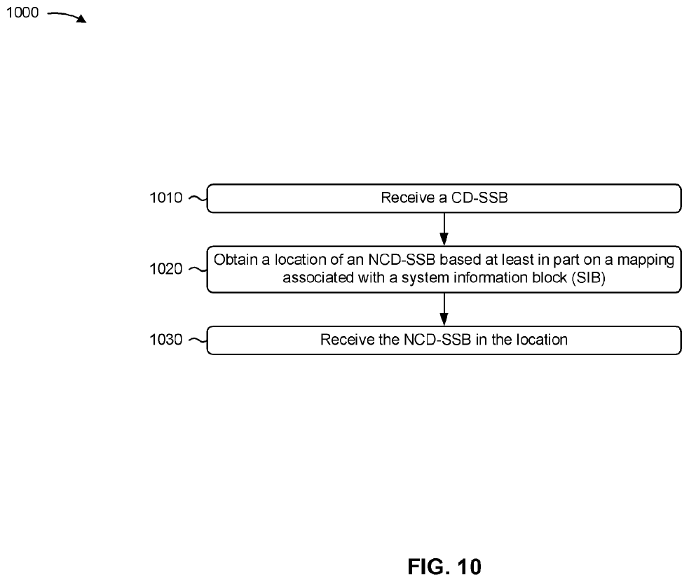

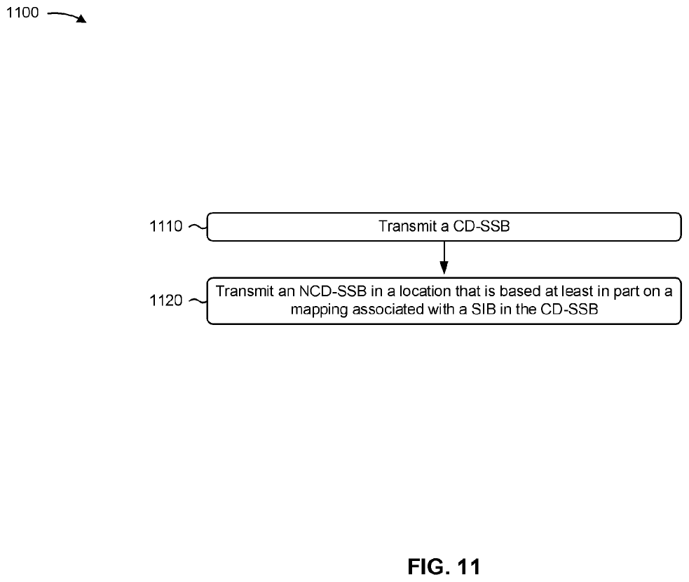

The controller/processor 240 of the network node 110, the controller/processor 280 of the UE 120, and/or any other component(s) of FIG. 2 may perform one or more techniques associated with using NCD-SSBs in an idle mode, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for receiving a CD-SSB; means for obtaining a location of an initial BWP that is specific to UEs with reduced capabilities based at least in part on system information; means for obtaining one or more parameters for an NCD-SSB based at least in part on a configuration for the initial BWP; and/or means for receiving the NCD-SSB in the initial BWP based at least in part on the one or more parameters. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for transmitting a CD-SSB; means for determining one or more parameters for an NCD-SSB based at least in part on a configuration for an initial BWP that is specific to UEs with reduced capabilities; and/or means for transmitting the NCD-SSB in the initial BWP based at least in part on the one or more parameters. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE 120 includes means for receiving a CD-SSB; means for obtaining a location of an NCD-SSB based at least in part on a mapping associated with a SIB; and/or means for receiving the NCD-SSB in the location.

In some aspects, the network node includes means for transmitting a CD-SSB; and/or means for transmitting an NCD-SSB in a location that is based at least in part on a mapping associated with a SIB in the CD-SSB.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

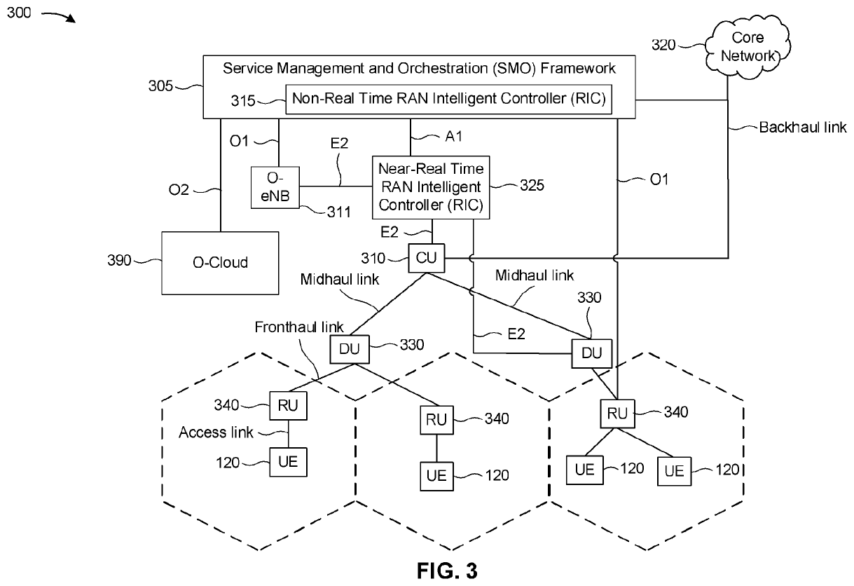

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of an SS hierarchy, in accordance with the present disclosure. As shown in FIG. 4, the SS hierarchy may include an SS burst set 405, which may include multiple SS bursts 410, shown as SS burst 0 through SS burst N−1, where N is a maximum number of repetitions of the SS burst 410 that may be transmitted by one or more network nodes. As further shown, each SS burst 410 may include one or more SSBs 415, shown as SSB 0 through SSB M−1, where M is a maximum number of SSBs 415 that can be carried by an SS burst 410. In some aspects, different SSBs 415 may be beam-formed differently (e.g., transmitted using different beams), and may be used for cell search, cell acquisition, beam management, and/or beam selection (e.g., as part of an initial network access procedure). An SS burst set 405 may be periodically transmitted by a wireless node (e.g., a network node 110), such as every X milliseconds, as shown in FIG. 4. In some aspects, an SS burst set 405 may have a fixed or dynamic length, shown as Y milliseconds in FIG. 4. In some cases, an SS burst set 405 or an SS burst 410 may be referred to as a discovery reference signal (DRS) transmission window or an SSB measurement time configuration (SMTC) window.

In some aspects, an SSB 415 may include resources that carry a PSS 420, an SSS 425, and/or a physical broadcast channel (PBCH) 430. In some aspects, multiple SSBs 415 are included in an SS burst 410 (e.g., with transmission on different beams), and the PSS 420, the SSS 425, and/or the PBCH 430 may be the same across each SSB 415 of the SS burst 410. In some aspects, a single SSB 415 may be included in an SS burst 410. In some aspects, the SSB 415 may be at least four symbols (e.g., OFDM symbols) in length, where each symbol carries one or more of the PSS 420 (e.g., occupying one symbol), the SSS 425 (e.g., occupying one symbol), and/or the PBCH 430 (e.g., occupying two symbols). In some aspects, an SSB 415 may be referred to as an SS/PBCH block.

In some aspects, the symbols of an SSB 415 are consecutive, as shown in FIG. 4. In some aspects, the symbols of an SSB 415 are non-consecutive. Similarly, in some aspects, one or more SSBs 415 of the SS burst 410 may be transmitted in consecutive radio resources (e.g., consecutive symbols) during one or more slots. Additionally, or alternatively, one or more SSBs 415 of the SS burst 410 may be transmitted in non-consecutive radio resources.

In some aspects, the SS bursts 410 may have a burst period, and the SSBs 415 of the SS burst 410 may be transmitted by a wireless node (e.g., a network node 110) according to the burst period. In this case, the SSBs 415 may be repeated during each SS burst 410. In some aspects, the SS burst set 405 may have a burst set periodicity, whereby the SS bursts 410 of the SS burst set 405 are transmitted by the wireless node according to the fixed burst set periodicity. In other words, the SS bursts 410 may be repeated during each SS burst set 405.

In some aspects, an SSB 415 may include an SSB index, which may correspond to a beam used to carry the SSB 415. A UE 120 may monitor for and/or measure SSBs 415 using different receive (Rx) beams during an initial network access procedure and/or a cell search procedure, among other examples. Based at least in part on the monitoring and/or measuring, the UE 120 may indicate one or more SSBs 415 with a best signal parameter (e.g., an RSRP parameter) to a network node 110 (e.g., directly or via one or more other network nodes). The network node 110 and the UE 120 may use the one or more indicated SSBs 415 to select one or more beams to be used for communication between the network node 110 and the UE 120 (e.g., for a random access channel (RACH) procedure). Additionally, or alternatively, the UE 120 may use the SSB 415 and/or the SSB index to determine a cell timing for a cell via which the SSB 415 is received (e.g., a serving cell).

An SSB may be a cell-defining, or a CD-SSB. A network node may transmit CD-SSBs during an RRC connected mode of a UE. The location of a CD-SSB may be defined in a specification and found in a synchronization raster of reference signals. A UE may find a CD-SSB using the synchronization raster. The CD-SSB may define system information for the serving cell, and the UE may use the CD-SSB to obtain the system information.

A RedCap UE, such as in 3GPP Release 17, has narrower bandwidth and may have different locations in a carrier to avoid congestion. The network node may transmit a CD-SSB to provide system information of the serving cell, but if the RedCap UE is within a narrower bandwidth configured around the CD-SSB, there can be congestion if there are a lot of RedCap UEs. A RedCap UE's bandwidth may be configured away from the CD-SSB location to avoid congestion, but then the RedCap UE is outside the CD-SSB. UEs need the CD-SSB for reference signal (RS) measurements.

The network node may configure an NCD-SSB. An NCD-SSB may be applicable to UEs with reduced capabilities, or RedCap UEs. The network node may configure an NCD-SSB in a RedCap UE's dedicated BWP in lieu of CD-SSB. The NCD-SSB may include attributes of an CD-SSB and may be used in procedures where traditionally the CD-SSB would be used. These procedures may include radio resource management (RRM) measurements, a radio link management (RLM) procedure, a beam failure recovery (BFR) procedure, interference management (IM) procedures, or a RACH procedure. However, the use of NCD-SSBs is limited to RedCap UEs in RRC connected mode only and not in RRC idle mode. RRC connected mode may include a mode that allows for full communication capabilities. RRC idle mode may mean that a connection needs to be established or reestablished for full communication capabilities. A RedCap UE in idle mode is not able to use an NCD-SSB for such procedures or determine which SSB to use. NCD-SSBs are not on the synchronization raster that is specified and that is indicated in stored configuration information.

Furthermore, in some examples, RedCap UEs may be configured with a separate initial BWP, in which a UE may perform paging monitoring and/or a RACH procedure. A RedCap-specific initial downlink BWP cannot contain an NCD-SSB. If the initial BWP is for paging monitoring, the initial BWP must contain the CD-SSB of the serving cell. This restricts the network's flexibility in configuring the location of an RedCap-specific initial BWP. If the initial BWP is for a RACH procedure, the initial BWP may or may not contain any type of SSB. In such examples, a UE may be expected to use the CD-SSB contained in the default initial BWP. This increases the latency of a RACH procedure.

According to various aspects described herein, a UE may use an NCD-SSB in RRC idle mode, in addition to RRC connected mode. The UE may learn the location of an NCD-SSB in an initial downlink BWP. The UE may be a RedCap UE and may be configured with a RedCap-specific initial downlink BWP. The network node may specify parameters of an NCD-SSB in an information element (IE) that is configured for the RedCap-specific initial downlink BWP. Such parameters may include a time and frequency resource location (e.g., an absolute radio frequency channel number (ARFCN)), a transmit power of the NCD-SSB, a periodicity of the NCD-SSB, and/or a timing offset of the NCD-SSB with respect to the CD-SSB of the cell. The initial downlink BWP may contain at most one SSB, either a CD-SSB or an NCD-SSB.

If a RedCap-specific initial downlink BWP is configured with a paging search space, the UE may expect that this BWP is configured with at least one SSB of either type, CD-SSB or NCD-SSB. In some aspects, the UE may perform an idle mode procedure based at least in part on the NCD-SSB. The idle mode procedure may include monitoring for paging in a paging search space in the initial BWP that is shared by the NCD-SSB. The paging search space and the NCD-SSB may be in the same initial BWP such that the UE can measure the NCD-SSB in the same BWP to synchronize with the system and then monitor paging. In some aspects, the idle mode procedure may include performing an RRM measurement based on the NCD-SSB instead of the CD-SSB.

If a RedCap-specific initial downlink BWP is configured with a random access response (RAR) search space, the UE may expect that this BWP is configured with at least one SSB of either type, CD-SSB or NCD-SSB. In some aspects, the idle mode procedure may include selecting a beam for a RACH based on a signal strength of the NCD-SSB. For example, the UE may measure the signal strength (e.g., RSRP) of NCD-SSB and then use the signal strength to select a suitable beam for the RACH procedure. This may include selecting the beam with the strongest RSRP. The UE may indicate to the network node which beam the UE prefers to use through the RACH occasion associated with the selected beam. The network node may preconfigure a mapping between RACH occasions and transmitted SSBs.

By using the NCD-SSB in idle mode, the UE may be able to obtain system information and perform idle mode procedures, or procedures that were previously unavailable during idle mode using an CD-SSB or an NCD-SSB. In this way, the UE may reduce latency by not waiting until RRC connected mode to perform procedures to improve communications.

As indicated above, FIG. 4 is provided as an example. Other examples may differ from what is described with regard to FIG. 4.

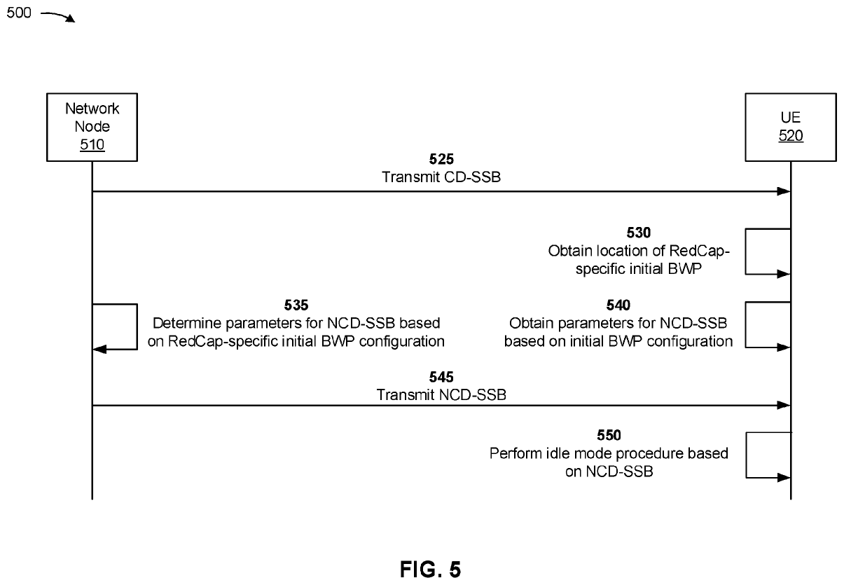

FIG. 5 is a diagram illustrating an example 500 associated with performing idle mode procedures based on an NCD-SSB, in accordance with the present disclosure. As shown in FIG. 5, a network node 510 (e.g., network node 110) and a UE 520 (e.g., UE 120) may communicate with one another via a wireless network (e.g., wireless network 100).

As shown by reference number 525, the network node 510 may transmit a CD-SSB. The UE 520 may use the synchronization raster to locate the CD-SSB for a frequency band. The UE 520 may obtain system information from the CD-SSB. The system information may be included in a SIB or a master information block (MIB) associated with the CD-SSB. As shown by reference number 530, the UE 520 may obtain a location of a RedCap-specific initial BWP based at least in part on the system information. As shown by reference number 535, the network node 510 may determine one or more parameters for an NCD-SSB based at least in part on a configuration for a RedCap-specific initial BWP. As shown by reference number 540, the UE 520 may obtain the one or more parameters for the NCD-SSB based at least in part on a configuration for the initial BWP. The UE 520 may receive the configuration for the initial BWP in the system information.

The UE 520 may enter an idle mode (e.g., RRC idle mode). As shown by reference number 545, the network node 510 may transmit the NCD-SSB. The UE 520 may receive the NCD-SSB in the initial BWP based at least in part on the one or more parameters. The one or more parameters may include a timing offset of the NCD-SSB with respect to the CD-SSB and/or a time and frequency location of the NCD-SSB. The one or more parameters may include a transmit power used for the NCD-SSB or a transmit power value.

As shown by reference number 550, the UE 520 may perform an idle mode procedure. The idle mode procedure may include monitoring a paging search space in the initial BWP shared by the NCD-SSB. The initial BWP may be configured with an RAR. The idle mode procedure may include selecting a beam for an RACH procedure based on a signal strength (e.g., RSRP) of the NCD-SSB. The idle mode procedure may include a preforming an RRM measurement based on the NCD-SSB.

By using the NCD-SSB for RRC idle mode procedures, the UE 520 may improve communications that previously relied on a CD-SSB or an NCD-SSB during RRC connected mode.

As indicated above, FIG. 5 is provided as an example. Other examples may differ from what is described with respect to FIG. 5.

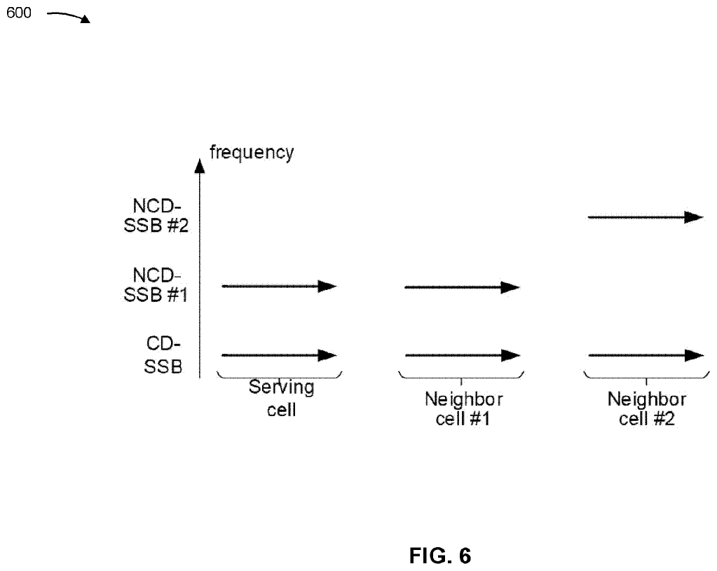

FIG. 6 is a diagram illustrating an example 600 associated with cell reselection, in accordance with the present disclosure.

In existing networks, neighbor cell measurements are performed on a CD-SSB. Intra-frequency and inter-frequency neighbor cells are advertised in SIB3 and SIB4, respectively. In some aspects, the UE may improve communications and reduce latency by performing neighbor cell measurements on the NCD-SSB (if configured) instead of the CD-SSB. For example, a RedCap UE's serving cell may be configured with an NCD-SSB in a RedCap-specific initial BWP. Therefore, the RedCap UE may perform serving cell measurements on the NCD-SSB. If neighbor cell #1 has the same configuration, as shown by example 600, then it is desirable for the RedCap UE to perform intra-frequency measurement on neighbor cell #1's NCD-SSB #1, instead of on the CD-SSB. Intra-frequency measurements involve measurements when the SSBs are on the same frequency. If neighbor cell #2's NCD-SSB is on a frequency different from CD-SSB and NCD-SSB #1, the UE may perform inter-frequency measurements on either SSB for neighbor cell #2.

Non-RedCap UEs and RedCap UEs may have different intra-frequency and inter-frequency measurement targets, when NCD-SSB is configured. For example 600, both neighbor cell #1 and neighbor cell #2 are intra-frequency neighbors for non-RedCap UEs. Whether a neighbor cell measurement is based on NCD-SSB or CD-SSB is up to network configuration, such as configurations in a SIB3 and a SIB4.

In some aspects, a new IE may be introduced in SIB3 and/or SIB4 that indicates a mapping between the CD-SSB and the NCD-SSB. The mapping may indicate an offset (e.g., in frequency) between a frequency location of the CD-SSB and a frequency location of the NCD-SSB. The mapping may indicate an offset (e.g., in frequency) between a start offset of the CD-SSB and a start offset of the NCD-SSB. The mapping may indicate an offset (e.g., amount of power) between a transmit power of the CD-SSB and a transmit power of the NCD-SSB. The mapping may indicate a scaling factor between a periodicity of the CD-SSB and a periodicity of the NCD-SSB. That is, the scaling factor may indicate that one periodicity is a multiple (integer or non-integer) of another periodicity.

As indicated above, FIG. 6 is provided as an example. Other examples may differ from what is described with regard to FIG. 6.

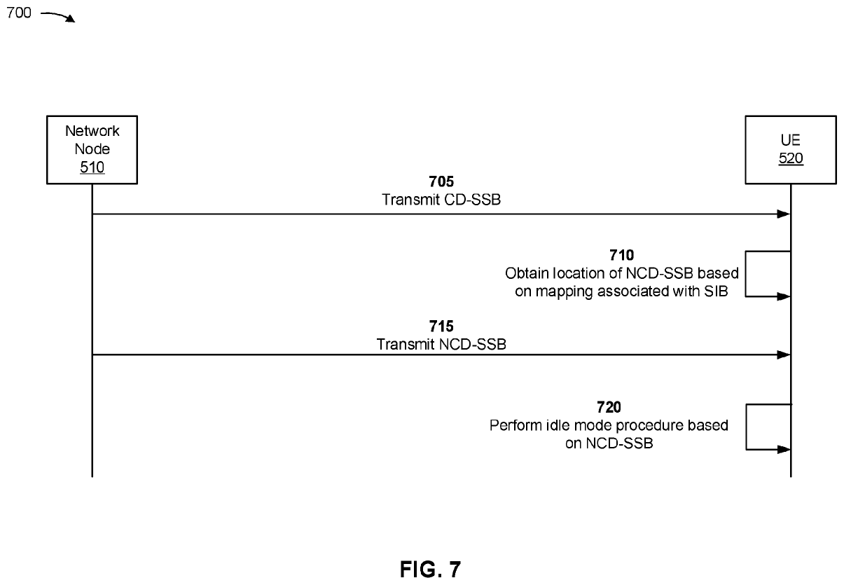

FIG. 7 is a diagram illustrating an example 700 associated with performing idle mode procedures based on an NCD-SSB, in accordance with the present disclosure.

Example 700 shows that the UE 520 (e.g., RedCap UE) may use mapping information to locate an NCD-SSB from a CD-SSB. As shown by reference number 705, the network node 510 may transmit a CD-SSB. The UE 520 may perform a search on the synchronization raster to locate or identify the CD-SSB for a target cell (e.g., serving cell, neighbor cell). The UE 520 may obtain system information from a SIB (or MIB) associated with the CD-SSB.

As shown by reference number 710, the UE 520 may obtain a location of the NCD-SSB based at least in part on a mapping associated with the SIB. For example, the UE 520 may apply an offset signaled in an IE in a SIB3 or a SIB4 to derive the time and frequency information of the NCD-SSB associated with the same cell, as well as other properties such as transmit power and periodicity. The IE in the SIB3 or the SIB4 may be a new IE (not previously included in the SIB 3 or the SIB4) that is dedicated for use by RedCap UEs. The SIB3 or the SIB4 may be a signal that is separate from and based on the CD-SSB. The SIBs may be transmitted only in the initial BWP that includes the CD-SSB or the SIBs may be for RedCap UE capabilities that are separately transmitted in the RedCap-specific initial BWP. Mapping information for the mapping may be frequency-specific.

In some aspects, the mapping information may be cell-specific. For example, information about the NCD-SSB may be provided by a new IE under an intra-frequency cell information IE (e.g., IntraFreqNeighCellInfo IE) in SIB3 and inter-frequency cell information IE (e.g., InterFreqCarrierFreqInfo IE) in SIB4. The information about NCD-SSB may be absolute values. Therefore, a RedCap UE may not need to find the CD-SSB to locate the NCD-SSB in a cell (although the CD-SSB may still be needed to locate the system information of a cell).

The UE 520 may be in idle mode. As shown by reference number 715, the network node 510 may transmit the NCD-SSB. The UE 520 may receive the NCD-SSB at the location. As shown by reference number 720, the UE 520 may perform an idle mode procedure based at least in part on the NCD-SSB.

In some aspects, if an NCD-SSB is configured for the UE 520 (as a RedCap UE) in an IntraFreqNeighCellInfo IE in SIB3 and/or an InterFreqCarrierFreqInfo IE in SIB4, then the UE 520 may use the configured NCD-SSB to perform the corresponding neighbor cell measurements, respectively. Otherwise, if no NCD-SSB parameters or configuration is present in the IntraFreqNeighCellInfo IE in SIB3 and/or the InterFreqCarrierFreqInfo IE in SIB4, the UE 520 may perform neighbor cell measurements in the same way as non-RedCap UEs. The UE 520 may perform measurements on the CD-SSB. Information (e.g., one or more parameters for an NCD-SSB) in one of these IEs indicates that the UE 520 is to perform measurements on the NCD-SSB. The parameters may be frequency-specific or cell-specific. That is, the presence or absence of the NCD-SSB in the IntraFreqNeighCellInfo IE in SIB3 and/or the InterFreqCarrierFreqInfo IE in SIB4 decides whether the UE 520 is to use the NCD-SSB of the corresponding neighbor cell or the CD-SSB of the neighbor cell to perform neighbor cell measurements.

When the UE 520 is configured for NCD-SSB, this may affect whether measurements of NCD-SSBs are intra-frequency and inter-frequency. In some aspects, the network node 510 may select a frequency for the NCD-SSB based at least in part on a selected classification (inter-frequency or intra-frequency) for NCD-SSB measurements. The selected classification may be based on the IE that includes the NCD-SSB parameters or an NCD-SSB configuration. For example, if the SSB used in a RedCap UE's serving cell measurement is on a different frequency from that of the SSB configured in the RedCap UE's IntraFreqNeighCellInfo IE, then the measurement on the corresponding neighbor cell may be classified as an inter-frequency measurement, although it is still an intra-frequency measurement for non-RedCap UEs in the same cell. If the SSB used in a RedCap UE's serving cell measurement is on the same frequency as that of the SSB configured in the RedCap UE's InterFreqNeighCellInfo IE, then the measurement on the corresponding neighbor cell may be classified as an intra-frequency measurement, although it is still an inter-frequency measurement for non-RedCap UEs in the same cell.

In some aspects, in response to NCD-SSB configuration information for RedCap UEs being included in an IE of the SIB for intra-frequency cell information, the UE 520 may perform a first measurement based on the NCD-SSB (the NCD-SSB being of a serving cell) and perform a second measurement based on an NCD-SSB of a neighboring cell, where a frequency of the NCD-SSB of the serving cell and a frequency of the NCD-SSB of the neighboring cell are a same frequency.

In some aspects, in response to NCD-SSB configuration information for RedCap UEs being included in an IE of the SIB for inter-frequency cell information, the UE 520 may perform a first measurement based on the NCD-SSB (the NCD-SSB being of a serving cell) and perform a second measurement based on an NCD-SSB of a neighboring cell, where a frequency of the NCD-SSB of the serving cell and a frequency of the NCD-SSB of the neighboring cell are different frequencies.

The frequency indicated in the SIB for the NCD-SSB may be inter-frequency or intra-frequency. In existing networks, cell reselection priority of a serving cell frequency is configured in a SIB2 and neighbor cell frequencies are configured in a SIB4. If an NCD-SSB is configured, then the intra-frequency in the SIB3 may become inter-frequency and the inter-frequency in the SIB4 may become intra-frequency for a RedCap UE. Therefore, the network node 510 may configured a cell selection priority for those frequencies separately from cell selection priorities for non-RedCap UEs. In some aspects, a RedCap-specific cell reselection priority may be introduced in, for example, the IntraFreqNeighCellInfo IE in the SIB2 and the InterFreqCarrierFreqInfo IE in the SIB4, if the NCD-SSB for idle mode is configured. If the NCD-SSB is configured, the frequency in SIB2 may become an inter-frequency, and the UE 520 may use the cell reselection priority under a cell reselection IE (e.g., cellReselectionPriority-NCD-SSB) IE instead of an existing IE in the SIB4. If the NCD-SSB is configured, the frequency in the SIB4 may become an intra-frequency, and the UE 520 may then use the cell reselection priority under, for example, the cellReselectionPriority-NCD-SSB IE in the SIB4 instead of an existing IE in the SIB2.

In some aspects, the UE 520 may perform cell reselection based at least in part on a cell reselection priority included in a RedCap-specific IE. The cell reselection priority may be included in an IE for intra-frequency cell information or in an IE for inter-frequency cell information.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120, UE 520) performs operations associated with NCD-SSBs in idle mode.

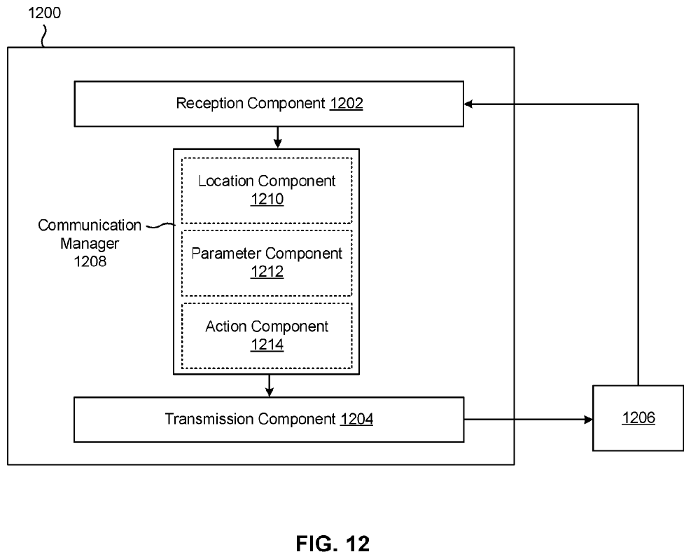

As shown in FIG. 8, in some aspects, process 800 may include receiving a CD-SSB (block 810). For example, the UE (e.g., using communication manager 1208 and/or reception component 1202 depicted in FIG. 12) may receive a CD-SSB, as described above.

As further shown in FIG. 8, in some aspects, process 800 may include obtaining a location of an initial BWP that is specific to UEs with reduced capabilities based at least in part on system information (block 820). For example, the UE (e.g., using communication manager 1208 and/or location component 1210 depicted in FIG. 12) may obtain a location of an initial BWP that is specific to UEs with reduced capabilities based at least in part on system information, as described above.

As further shown in FIG. 8, in some aspects, process 800 may include obtaining one or more parameters for an NCD-SSB based at least in part on a configuration for the initial BWP (block 830). For example, the UE (e.g., using communication manager 1208 and/or parameter component 1212 depicted in FIG. 12) may obtain one or more parameters for an NCD-SSB based at least in part on a configuration for the initial BWP, as described above.

As further shown in FIG. 8, in some aspects, process 800 may include receiving the NCD-SSB in the initial BWP based at least in part on the one or more parameters (block 840). For example, the UE (e.g., using communication manager 1208 and/or reception component 1202 depicted in FIG. 12) may receive the NCD-SSB in the initial BWP based at least in part on the one or more parameters, as described above.

Process 800 may include additional aspects, such as any single aspect or any combination of aspects described below and/or in connection with one or more other processes described elsewhere herein.

In a first aspect, the one or more parameters include a timing offset of the NCD-SSB with respect to the CD-SSB.

In a second aspect, alone or in combination with the first aspect, the one or more parameters include a time and frequency location of the NCD-SSB.

In a third aspect, alone or in combination with one or more of the first and second aspects, the one or more parameters include a transmit power used for the NCD-SSB.

In a fourth aspect, alone or in combination with one or more of the first through third aspects, the one or more parameters include a transmit power value.

In a fifth aspect, alone or in combination with one or more of the first through fourth aspects, process 800 includes performing an idle mode procedure based at least in part on the NCD-SSB.

In a sixth aspect, alone or in combination with one or more of the first through fifth aspects, the idle mode procedure includes monitoring for paging in a paging search space in the initial BWP that is shared by the NCD-SSB.

In a seventh aspect, alone or in combination with one or more of the first through sixth aspects, the initial BWP is configured with a RAR search space.

In an eighth aspect, alone or in combination with one or more of the first through seventh aspects, the idle mode procedure includes selecting a beam for a RACH procedure based on a signal strength of the NCD-SSB.

In a ninth aspect, alone or in combination with one or more of the first through eighth aspects, the idle mode procedure includes performing an RRM measurement based on the NCD-SSB.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110, network node 510) performs operations associated with NCD-SSBs in an idle mode.

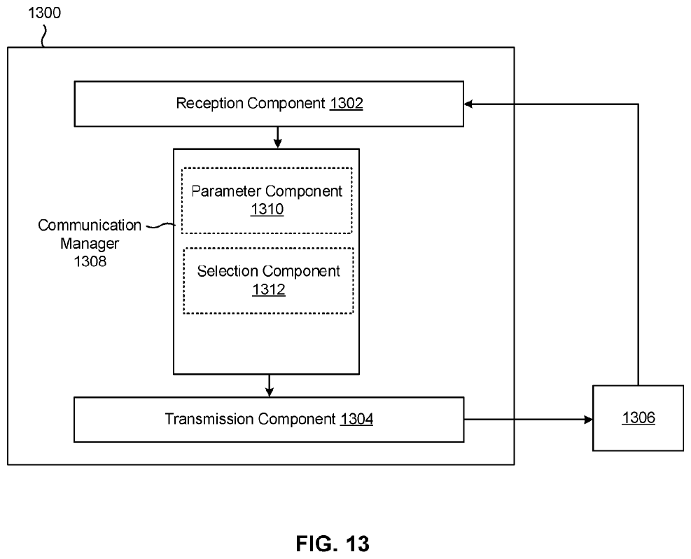

As shown in FIG. 9, in some aspects, process 900 may include transmitting a CD-SSB (block 910). For example, the network node (e.g., using communication manager 1308 and/or transmission component 1304 depicted in FIG. 13) may transmit a CD-SSB, as described above.

As further shown in FIG. 9, in some aspects, process 900 may include determining one or more parameters for an NCD-SSB based at least in part on a configuration for an initial BWP that is specific to UEs with reduced capabilities (block 920). For example, the network node (e.g., using communication manager 1308 and/or parameter component 1310 depicted in FIG. 13) may determine one or more parameters for an NCD-SSB based at least in part on a configuration for an initial BWP that is specific to UEs with reduced capabilities, as described above.

As further shown in FIG. 9, in some aspects, process 900 may include transmitting the NCD-SSB in the initial BWP based at least in part on the one or more parameters (block 930). For example, the network node (e.g., using communication manager 1308 and/or transmission component 1304 depicted in FIG. 13) may transmit the NCD-SSB in the initial BWP based at least in part on the one or more parameters, as described above.

Process 900 may include additional aspects, such as any single aspect or any combination of aspects described below and/or in connection with one or more other processes described elsewhere herein.

In a first aspect, the one or more parameters include one or more of a timing offset of the NCD-SSB with respect to the CD-SSB, a time and frequency location of the NCD-SSB, a transmit power used for the NCD-SSB, an initial BWP that is specific to UEs with reduced capabilities, or a transmit power value.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120, UE 520) performs operations associated with NCD-SSBs in an idle mode.

As shown in FIG. 10, in some aspects, process 1000 may include receiving a CD-SSB (block 1010). For example, the UE (e.g., using communication manager 1208 and/or reception component 1202 depicted in FIG. 13) may receive a CD-SSB, as described above.

As further shown in FIG. 10, in some aspects, process 1000 may include obtaining a location of an NCD-SSB based at least in part on a mapping associated with a SIB (block 1020). For example, the UE (e.g., using communication manager 1208 and/or location component 1210 depicted in FIG. 13) may obtain a location of an NCD-SSB based at least in part on a mapping associated with a SIB, as described above.

As further shown in FIG. 10, in some aspects, process 1000 may include receiving the NCD-SSB in the location (block 1030). For example, the UE (e.g., using communication manager 1208 and/or reception component 1202 depicted in FIG. 13) may receive the NCD-SSB in the location, as described above.

Process 1000 may include additional aspects, such as any single aspect or any combination of aspects described below and/or in connection with one or more other processes described elsewhere herein.

In a first aspect, the mapping indicates an offset between a frequency location of the CD-SSB and a frequency location of the NCD-SSB. In a second aspect, alone or in combination with the first aspect, the mapping indicates an offset between a start offset of the CD-SSB and a start offset of the NCD-SSB. In a third aspect, alone or in combination with one or more of the first and second aspects, the mapping indicates an offset between a transmit power of the CD-SSB and a transmit power of the NCD-SSB. In a fourth aspect, alone or in combination with one or more of the first through third aspects, the mapping indicates a scaling factor between a periodicity of the CD-SSB and a periodicity of the NCD-SSB.

In a fifth aspect, alone or in combination with one or more of the first through fourth aspects, the mapping is included in a frequency-specific information element. In a sixth aspect, alone or in combination with one or more of the first through fifth aspects, the mapping is included in a cell-specific information element.

In a seventh aspect, alone or in combination with one or more of the first through sixth aspects, process 1000 includes performing a first measurement based on the NCD-SSB, the NCD-SSB being of a serving cell, and performing a second measurement based on an NCD-SSB of a neighboring cell, where a frequency of the NCD-SSB of the serving cell and a frequency of the NCD-SSB of the neighboring cell are a same frequency.

In an eighth aspect, alone or in combination with one or more of the first through seventh aspects, process 1000 includes performing a first measurement based on the NCD-SSB, the NCD-SSB being of a serving cell, and performing a second measurement based on an NCD-SSB of a neighboring cell, where a frequency of the NCD-SSB of the serving cell and a frequency of the NCD-SSB of the neighboring cell are different frequencies.

In a ninth aspect, alone or in combination with one or more of the first through eighth aspects, a frequency indicated in the SIB for the NCD-SSB is inter-frequency or intra-frequency, and process 1000 includes performing cell reselection based at least in part on a cell reselection priority included in an information element that is specific to UEs with reduced capabilities.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110, network node 510) performs operations associated with NCD-SSBs in an idle mode.

As shown in FIG. 11, in some aspects, process 1100 may include transmitting a CD-SSB (block 1110). For example, the network node (e.g., using communication manager 1308 and/or transmission component 1304 depicted in FIG. 13) may transmit a CD-SSB, as described above.

As further shown in FIG. 11, in some aspects, process 1100 may include transmitting an NCD-SSB in a location that is based at least in part on a mapping associated with a SIB in the CD-SSB (block 1120). For example, the network node (e.g., using communication manager 1308 and/or transmission component 1304 depicted in FIG. 13) may transmit an NCD-SSB in a location that is based at least in part on a mapping associated with a SIB in the CD-SSB, as described above.

Process 1100 may include additional aspects, such as any single aspect or any combination of aspects described below and/or in connection with one or more other processes described elsewhere herein.

In a first aspect, the mapping indicates one or more of an offset between a frequency location of the CD-SSB and a frequency location of the NCD-SSB, an offset between a start offset of the CD-SSB and a start offset of the NCD-SSB, an offset between a transmit power of the CD-SSB and a transmit power of the NCD-SSB, or a scaling factor between a periodicity of the CD-SSB and a periodicity of the NCD-SSB.

In a second aspect, alone or in combination with the first aspect, process 1100 includes transmitting one or more parameters for the NCD-SSB in an IE for intra-frequency cell information in the SIB or in an IE for inter-frequency cell information in the SIB to indicate that a UE is to perform neighbor cell measurements on the NCD-SSB.

In a third aspect, alone or in combination with one or more of the first and second aspects, the mapping or the one or more parameters is frequency-specific or cell-specific.

In a fourth aspect, alone or in combination with one or more of the first through third aspects, process 1100 includes selecting a frequency for the NCD-SSB based at least in part on a selected classification for NCD-SSB measurements

In a fifth aspect, alone or in combination with one or more of the first through fourth aspects, process 1100 includes transmitting, in the SIB or another SIB, a cell reselection priority that is specific to neighbor cells with measurements that are based on an NCD-SSB and not on a CD-SSB

In a sixth aspect, alone or in combination with one or more of the first through fifth aspects, the cell reselection priority is included in an IE for intra-frequency cell information or in an IE for inter-frequency cell information. In a seventh aspect, alone or in combination with one or more of the first through sixth aspects, process 1100 includes transmitting NCD-SSB configuration information for UEs with reduced capacities in an IE for intra-frequency cell information or in an IE for inter-frequency cell information.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE (e.g., UE 120, UE 520), or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 1208. The communication manager 1208 may control and/or otherwise manage one or more operations of the reception component 1202 and/or the transmission component 1204. In some aspects, the communication manager 1208 may include one or more antennas, a modem, a controller/processor, a memory, or a combination thereof, of the UE described in connection with FIG. 2. The communication manager 1208 may be, or be similar to, the communication manager 140 depicted in FIGS. 1 and 2. For example, in some aspects, the communication manager 1208 may be configured to perform one or more of the functions described as being performed by the communication manager 140. In some aspects, the communication manager 1208 may include the reception component 1202 and/or the transmission component 1204. The communication manager 1208 may include a location component 1210, a parameter component 1212, and/or an action component 1214, among other examples.

In some aspects, the apparatus 1200 may be configured to perform one or more operations described herein in connection with FIGS. 1-9. Additionally, or alternatively, the apparatus 1200 may be configured to perform one or more processes described herein, such as process 800 of FIG. 8, process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

In some aspects, the reception component 1202 may receive a CD-SSB. The location component 1210 may obtain a location of an initial BWP that is specific to UEs with reduced capabilities based at least in part on system information. The parameter component 1212 may obtain one or more parameters for an NCD-SSB based at least in part on a configuration for the initial BWP. The reception component 1202 may receive the NCD-SSB in the initial BWP based at least in part on the one or more parameters. The action component 1214 may perform an idle mode procedure based at least in part on the NCD-SSB.

In some aspects, the reception component 1202 may receive a CD-SSB. The location component 1210 may obtain a location of an NCD-SSB based at least in part on a mapping associated with a SIB. The reception component 1202 may receive the NCD-SSB in the location.

The action component 1214 may perform a first measurement based on the NCD-SSB, the NCD-SSB being of a serving cell. The action component 1214 may perform a second measurement based on an NCD-SSB of a neighboring cell, where a frequency of the NCD-SSB of the serving cell and a frequency of the NCD-SSB of the neighboring cell are a same frequency. The action component 1214 may perform a first measurement based on the NCD-SSB, the NCD-SSB being of a serving cell. The action component 1214 may perform a second measurement based on an NCD-SSB of a neighboring cell, where a frequency of the NCD-SSB of the serving cell and a frequency of the NCD-SSB of the neighboring cell are different frequencies.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node (e.g., network node 110, network node 510), or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 1308. The communication manager 1308 may control and/or otherwise manage one or more operations of the reception component 1302 and/or the transmission component 1304. In some aspects, the communication manager 1308 may include one or more antennas, a modem, a controller/processor, a memory, or a combination thereof, of the network node described in connection with FIG. 2. The communication manager 1308 may be, or be similar to, the communication manager 150 depicted in FIGS. 1 and 2. For example, in some aspects, the communication manager 1308 may be configured to perform one or more of the functions described as being performed by the communication manager 150. In some aspects, the communication manager 1308 may include the reception component 1302 and/or the transmission component 1304. The communication manager 1308 may include a parameter component 1310 and/or a selection component 1312, among other examples.

In some aspects, the apparatus 1300 may be configured to perform one or more operations described herein in connection with FIGS. 1-7. Additionally, or alternatively, the apparatus 1300 may be configured to perform one or more processes described herein, such as process 900 of FIG. 9, process 1100 of FIG. 11 or a combination thereof. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

In some aspects, the transmission component 1304 may transmit a CD-SSB.

The parameter component 1310 may determine one or more parameters for an NCD-SSB based at least in part on a configuration for an initial BWP that is specific to UEs with reduced capabilities. The transmission component 1304 may transmit the NCD-SSB in the initial BWP based at least in part on the one or more parameters.

In some aspects, the transmission component 1304 may transmit a CD-SSB. The transmission component 1304 may transmit an NCD-SSB in a location that is based at least in part on a mapping associated with a SIB in the CD-SSB.

The transmission component 1304 may transmit one or more parameters for the NCD-SSB in an IE for intra-frequency cell information in the SIB or in an IE for inter-frequency cell information in the SIB to indicate that a user equipment is to perform neighbor cell measurements on the NCD-SSB.

The selection component 1312 may select a frequency for the NCD-SSB based at least in part on a selected classification for NCD-SSB measurements. The transmission component 1304 may transmit, in the SIB or another SIB, a cell reselection priority that is specific to neighbor cells with measurements that are based on an NCD-SSB and not on a CD-SSB. The transmission component 1304 may transmit NCD-SSB configuration information for UEs with reduced capacities in an IE for intra-frequency cell information or in an IE for inter-frequency cell information.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving a cell-defining (CD) synchronization signal burst (SSB); obtaining a location of an initial bandwidth part (BWP) that is specific to UEs with reduced capabilities based at least in part on system information; obtaining one or more parameters for a non-CD (NCD) SSB based at least in part on a configuration for the initial BWP; and receiving the NCD-SSB in the initial BWP based at least in part on the one or more parameters.

Aspect 2: The method of Aspect 1, wherein the one or more parameters include a timing offset of the NCD-SSB with respect to the CD-SSB.

Aspect 3: The method of Aspect 1 or 2, wherein the one or more parameters include a time and frequency location of the NCD-SSB.

Aspect 4: The method of any of Aspects 1-3, wherein the one or more parameters include a transmit power used for the NCD-SSB.

Aspect 5: The method of any of Aspects 1-4, wherein the one or more parameters include a transmit power value.

Aspect 6: The method of any of Aspects 1-5, further comprising performing an idle mode procedure based at least in part on the NCD-SSB.

Aspect 7: The method of Aspect 6, wherein the idle mode procedure includes monitoring for paging in a paging search space in the initial BWP that is shared by the NCD-SSB.

Aspect 8: The method of Aspect 6 or 7, wherein the initial BWP is configured with a random access channel response search space.

Aspect 9: The method of any of Aspects 6-8, wherein the idle mode procedure includes selecting a beam for a random access channel procedure based on a signal strength of the NCD-SSB.

Aspect 10: The method of any of Aspects 6-8, wherein the idle mode procedure includes performing a radio resource management measurement based on the NCD-SSB.

Aspect 11: A method of wireless communication performed by a network node, comprising: transmitting a cell-defining (CD) synchronization signal burst (SSB); determining one or more parameters for a non-CD (NCD) SSB based at least in part on a configuration for an initial bandwidth part (BWP) that is specific to UEs with reduced capabilities; and transmitting the NCD-SSB in the initial BWP based at least in part on the one or more parameters.

Aspect 12: The method of Aspect 11, wherein the one or more parameters include one or more of a timing offset of the NCD-SSB with respect to the CD-SSB, a time and frequency location of the NCD-SSB, a transmit power used for the NCD-SSB, an initial bandwidth part (BWP) that is specific to UEs with reduced capabilities, or a transmit power value.

Aspect 13: A method of wireless communication performed by a user equipment (UE), comprising: receiving a cell-defining (CD) synchronization signal burst (SSB); obtaining a location of a non-CD (NCD) SSB based at least in part on a mapping associated with a system information block (SIB); and receiving the NCD-SSB in the location.

Aspect 14: The method of Aspect 13, wherein the mapping indicates an offset between a frequency location of the CD-SSB and a frequency location of the NCD-SSB.

Aspect 15: The method of Aspect 13 or 14, wherein the mapping indicates an offset between a start offset of the CD-SSB and a start offset of the NCD-SSB.

Aspect 16: The method of any of Aspects 13-15, wherein the mapping indicates an offset between a transmit power of the CD-SSB and a transmit power of the NCD-SSB.

Aspect 17: The method of any of Aspects 13-16, wherein the mapping indicates a scaling factor between a periodicity of the CD-SSB and a periodicity of the NCD-SSB.

Aspect 18: The method of any of Aspects 13-17, wherein the mapping is included in a frequency-specific information element.

Aspect 19: The method of any of Aspects 13-17, wherein the mapping is included in a cell-specific information element.

Aspect 20: The method of any of Aspects 13-19, further comprising, in response to NCD-SSB configuration information for UEs with reduced capacities being included in an information element of the SIB for intra-frequency cell information: performing a first measurement based on the NCD-SSB, the NCD-SSB being of a serving cell; and performing a second measurement based on an NCD-SSB of a neighboring cell, wherein a frequency of the NCD-SSB of the serving cell and a frequency of the NCD-SSB of the neighboring cell are a same frequency.

Aspect 21: The method of any of Aspects 13-19, further comprising, in response to NCD-SSB configuration information for UEs with reduced capacities being included in an information element of the SIB for inter-frequency cell information: performing a first measurement based on the NCD-SSB, the NCD-SSB being of a serving cell; and performing a second measurement based on an NCD-SSB of a neighboring cell, wherein a frequency of the NCD-SSB of the serving cell and a frequency of the NCD-SSB of the neighboring cell are different frequencies.

Aspect 22: The method of any of Aspects 13-21, wherein a frequency indicated in the SIB for the NCD-SSB is inter-frequency or intra-frequency, and wherein the method further includes performing cell reselection based at least in part on a cell reselection priority included in an information element that is specific to UEs with reduced capabilities.

Aspect 23: A method of wireless communication performed by a network node, comprising: transmitting a cell-defining (CD) synchronization signal burst (SSB); and transmitting a non-CD (NCD) SSB in a location that is based at least in part on a mapping associated with a system information block (SIB) in the CD-SSB.

Aspect 24: The method of Aspect 23, wherein the mapping indicates one or more of an offset between a frequency location of the CD-SSB and a frequency location of the NCD-SSB, an offset between a start offset of the CD-SSB and a start offset of the NCD-SSB, an offset between a transmit power of the CD-SSB and a transmit power of the NCD-SSB, or a scaling factor between a periodicity of the CD-SSB and a periodicity of the NCD-SSB.

Aspect 25: The method of Aspect 23 or 24, further comprising transmitting one or more parameters for the NCD-SSB in an information element (IE) for intra-frequency cell information in the SIB or in an IE for inter-frequency cell information in the SIB to indicate that a user equipment is to perform neighbor cell measurements on the NCD-SSB.

Aspect 26: The method of Aspect 25, wherein the mapping or the one or more parameters is frequency-specific or cell-specific.

Aspect 27: The method of any of Aspects 23-26, further comprising selecting a frequency for the NCD-SSB based at least in part on a selected classification for NCD-SSB measurements

Aspect 28: The method of any of Aspects 23-26, further comprising transmitting, in the SIB or another SIB, a cell reselection priority that is specific to neighbor cells with measurements that are based on an NCD-SSB and not on a CD-SSB.

Aspect 29: The method of Aspect 28, wherein the cell reselection priority is included in an information element (IE) for intra-frequency cell information or in an IE for inter-frequency cell information.

Aspect 30: The method of any of Aspects 23-29, further comprising transmitting NCD-SSB configuration information for UEs with reduced capacities in an information element (IE) for intra-frequency cell information or in an IE for inter-frequency cell information.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a cell-defining (CD) synchronization signal burst (SSB);
obtain a location of an initial bandwidth part (BWP) that is specific to UEs with reduced capabilities based at least in part on system information;
obtain one or more parameters for a non-CD (NCD) SSB based at least in part on a configuration for the initial BWP; and
receive the NCD-SSB in the initial BWP based at least in part on the one or more parameters.

2. The UE of claim 1, wherein the one or more parameters include a timing offset of the NCD-SSB with respect to the CD-SSB.

3. The UE of claim 1, wherein the one or more parameters include a time and frequency location of the NCD-SSB.

4. The UE of claim 1, wherein the one or more parameters include a transmit power used for the NCD-SSB.

5. The UE of claim 1, wherein the one or more parameters include a transmit power value.

6. The UE of claim 1, wherein the one or more processors are configured to perform an idle mode procedure based at least in part on the NCD-SSB.

7. The UE of claim 6, wherein the idle mode procedure includes monitoring for paging in a paging search space in the initial BWP that is shared by the NCD-SSB.

8. The UE of claim 6, wherein the initial BWP is configured with a random access channel response search space.

9. The UE of claim 6, wherein the idle mode procedure includes selecting a beam for a random access channel procedure based on a signal strength of the NCD-SSB.

10. The UE of claim 6, wherein the idle mode procedure includes performing a radio resource management measurement based on the NCD-SSB.

11. A network node for wireless communication, comprising:
a memory; and
one or more processors, coupled to the memory, configured to:
transmit a cell-defining (CD) synchronization signal burst (SSB);
determine one or more parameters for a non-CD (NCD) SSB based at least in part on a configuration for an initial bandwidth part (BWP) that is specific to UEs with reduced capabilities; and
transmit the NCD-SSB in the initial BWP based at least in part on the one or more parameters.

12. The network node of claim 11, wherein the one or more parameters include one or more of a timing offset of the NCD-SSB with respect to the CD-SSB, a time and frequency location of the NCD-SSB, a transmit power used for the NCD-SSB, an initial bandwidth part (BWP) that is specific to UEs with reduced capabilities, or a transmit power value.

13. A user equipment (UE) for wireless communication, comprising:
a memory; and
one or more processors, coupled to the memory, configured to:
receive a cell-defining (CD) synchronization signal burst (SSB);
obtain a location of a non-CD (NCD) SSB based at least in part on a mapping associated with a system information block (SIB); and
receive the NCD-SSB in the location.

14. The UE of claim 13, wherein the mapping indicates an offset between a frequency location of the CD-SSB and a frequency location of the NCD-SSB.

15. The UE of claim 13, wherein the mapping indicates an offset between a start offset of the CD-SSB and a start offset of the NCD-SSB.

16. The UE of claim 13, wherein the mapping indicates an offset between a transmit power of the CD-SSB and a transmit power of the NCD-SSB.

17. The UE of claim 13, wherein the mapping indicates a scaling factor between a periodicity of the CD-SSB and a periodicity of the NCD-SSB.

18. The UE of claim 13, wherein the mapping is included in a frequency-specific information element.

19. The UE of claim 13, wherein the mapping is included in a cell-specific information element.

20. The UE of claim 13, wherein the one or more processors are configured to, in response to NCD-SSB configuration information for UEs with reduced capacities being included in an information element of the SIB for intra-frequency cell information:
perform a first measurement based on the NCD-SSB, the NCD-SSB being of a serving cell; and
perform a second measurement based on an NCD-SSB of a neighboring cell, wherein a frequency of the NCD-SSB of the serving cell and a frequency of the NCD-SSB of the neighboring cell are a same frequency.

21. The UE of claim 13, wherein the one or more processors are configured to, in response to NCD-SSB configuration information for UEs with reduced capacities being included in an information element of the SIB for inter-frequency cell information:
perform a first measurement based on the NCD-SSB, the NCD-SSB being of a serving cell; and
perform a second measurement based on an NCD-SSB of a neighboring cell, wherein a frequency of the NCD-SSB of the serving cell and a frequency of the NCD-SSB of the neighboring cell are different frequencies.

22. The UE of claim 13, wherein a frequency indicated in the SIB for the NCD-SSB is inter-frequency or intra-frequency, and wherein the one or more processors are configured to perform cell reselection based at least in part on a cell reselection priority included in an information element that is specific to UEs with reduced capabilities.

23. A network node for wireless communication, comprising:
a memory; and
one or more processors, coupled to the memory, configured to:
transmit a cell-defining (CD) synchronization signal burst (SSB); and
transmit a non-CD (NCD) SSB in a location that is based at least in part on a mapping associated with a system information block (SIB) in the CD-SSB.

24. The network node of claim 23, wherein the mapping indicates one or more of an offset between a frequency location of the CD-SSB and a frequency location of the NCD-SSB, an offset between a start offset of the CD-SSB and a start offset of the NCD-SSB, an offset between a transmit power of the CD-SSB and a transmit power of the NCD-SSB, or a scaling factor between a periodicity of the CD-SSB and a periodicity of the NCD-SSB.

25. The network node of claim 23, wherein the one or more processors are configured to transmit one or more parameters for the NCD-SSB in an information element (IE) for intra-frequency cell information in the SIB or in an IE for inter-frequency cell information in the SIB to indicate that a user equipment is to perform neighbor cell measurements on the NCD-SSB.

26. The network node of claim 25, wherein the mapping or the one or more parameters is frequency-specific or cell-specific.

27. The network node of claim 23, wherein the one or more processors are configured to select a frequency for the NCD-SSB based at least in part on a selected classification for NCD-SSB measurements.

28. The network node of claim 23, wherein the one or more processors are configured to transmit, in the SIB or another SIB, a cell reselection priority that is specific to neighbor cells with measurements that are based on an NCD-SSB and not on a CD-SSB.

29. The network node of claim 28, wherein the cell reselection priority is included in an information element (IE) for intra-frequency cell information or in an IE for inter-frequency cell information.

30. The network node of claim 29, wherein the one or more processors are configured to transmit NCD-SSB configuration information for UEs with reduced capacities in an information element (IE) for intra-frequency cell information or in an IE for inter-frequency cell information.
